(19) United States
(12) Patent Application Publication
(10) Pub. No.: US 2021/0029904 A1
(43) Pub. Date: Feb. 4, 2021

(54) PORTABLE CONTAINER AND DEVICE FOR PLANTING HYDROPONIC VEGETABLE

(71) Applicant: Yu Shen WANG, Taichung City (TW)

(72) Inventor: Yu Shen WANG, Taichung City (TW)

(21) Appl. No.: 16/525,201

(22) Filed: Jul. 29, 2019

(51) Int. Cl. A01G 31/06; A01G 22/00

(52) U.S. Cl. CPC A01G 31/06; A01G 22/00

(57) ABSTRACT

A portable container for planting a hydroponic vegetable is obliquely accommodated in and is removed from a portable device. The portable container contains: a first cup and a second cup. The first cup includes a first peripheral fence, a first bottom, a first accommodation chamber, at least one first planting orifice, and at least through orifice. The at least one first planting orifice is configured to accommodate a porous carrier. The second cup is fixed below the first cup and includes a second peripheral fence, a second bottom, and a second accommodation chamber. The second peripheral fence has a discharge orifice and a plug. An outer diameter of the drain pipe is more than an inner diameter of the plug, a lower end of the drain pipe is pressed into the plug, and the drain pipe includes a nylon mesh adhered on an upper end thereof.

### FIELD OF THE INVENTION

The present invention relates to a portable container for planting a hydroponic vegetable which is obliquely accommodated in and is removed from a portable device.

### BACKGROUND OF THE INVENTION

A conventional container for planting a vegetable contains a basket and a body in which culture fluid and water are accommodated, wherein the basket is fixed into an opening of the body and does not contact the body so that the vegetable is planted in the basket, and a root of the vegetable is socked in the culture fluid.

Conventional containers for planting vegetables are disclosed in TW Patent Nos. M490733, M494483, M559582, M556475, M497915, and M497915 respectively. However, such Conventional containers are complicated and cause high fabrication cost. In addition, it is troublesome to harvest the vegetables from the container.

A conventional container is disclosed in TW Patent No. M546087 and contains a hydroponic vegetable plate configured to plant the hydroponic vegetable in high planting cost. Another conventional container is disclosed in TW Patent No. M571654 and contains a connection member configured to connect two plating containers so as to simplify water supplement, but it occupies a large area. Another conventional container is disclosed in TW Patent No. I584724 and contains a mounting rack for accommodating multiple holders so as to reduce occupy area. However, it is inconvenient to harvest vegetables.

The present invention has arisen to mitigate and/or obviate the afore-described disadvantages.

### SUMMARY OF THE INVENTION

The primary objective of the present invention is to provide a portable container for planting a hydroponic vegetable which is obliquely accommodated in and is removed from a portable device.

To obtain above-mentioned objects, a portable container provided by the present invention contains: a first cup and a second cup.

The first cup includes a first peripheral fence, a first bottom, a first accommodation chamber defined between the first peripheral fence and the first bottom.

The first cup includes at least one first planting orifice and at least through orifice which are formed adjacent to the first peripheral fence. The at least one first planting orifice is configured to accommodate a porous carrier so that the hydroponic vegetable grows in the first accommodation chamber.

The second cup is fixed below the first cup and includes a second peripheral fence and a second bottom. A perimeter of the first peripheral fence is less than the second peripheral fence so that a second accommodation chamber is defined among the second peripheral fence, the first bottom, and the second bottom, and a root of the hydroponic vegetable grows.

The second peripheral fence has a discharge orifice.

A plug is connected with the discharge orifice.

An outer diameter of the drain pipe is more than an inner diameter of the plug, a lower end of the drain pipe is pressed into the plug, and the drain pipe includes a nylon mesh adhered on an upper end thereof.

Each portable containers is obliquely accommodated in the portable device, the at least one first planting orifice is formed on a lowest position of the first bottom, and the discharge orifice is formed on a lowest position of the second bottom;

A fluid is dropped into the second accommodation chamber along the at least one first planting orifice.

### BRIEF DESCRIPTION OF THE DRAWINGS

FIG. 1 is a perspective view showing the exploded components of a portable container for planting a hydroponic vegetable according to a preferred embodiment of the present invention.

FIG. 2 is a cross sectional view showing the assembly of the portable container for planting the hydroponic vegetable according to the preferred embodiment of the present invention.

FIG. 3 is a cross sectional view showing the application of the portable container for planting the hydroponic vegetable according to the preferred embodiment of the present invention.

FIG. 4 is a perspective view showing the application of the portable container for planting the hydroponic vegetable according to the preferred embodiment of the present invention.

FIG. 5 is a perspective view showing the exploded components of the portable container and a portable device for planting the hydroponic vegetable according to the preferred embodiment of the present invention.

FIG. 6 is a perspective view showing the assembly of a part of the portable device for planting the hydroponic vegetable according to the preferred embodiment of the present invention.

FIG. 7 is a cross sectional view showing the application of the portable container and the portable device for planting the hydroponic vegetable according to the preferred embodiment of the present invention.

FIG. 8 is a cross sectional view showing the assembly of the portable device for planting the hydroponic vegetable according to the preferred embodiment of the present invention.

FIG. 9 is a perspective view showing the application of the portable container and the portable device for planting the hydroponic vegetable according to the preferred embodiment of the present invention.

### DETAILED DESCRIPTION OF THE PREFERRED EMBODIMENTS

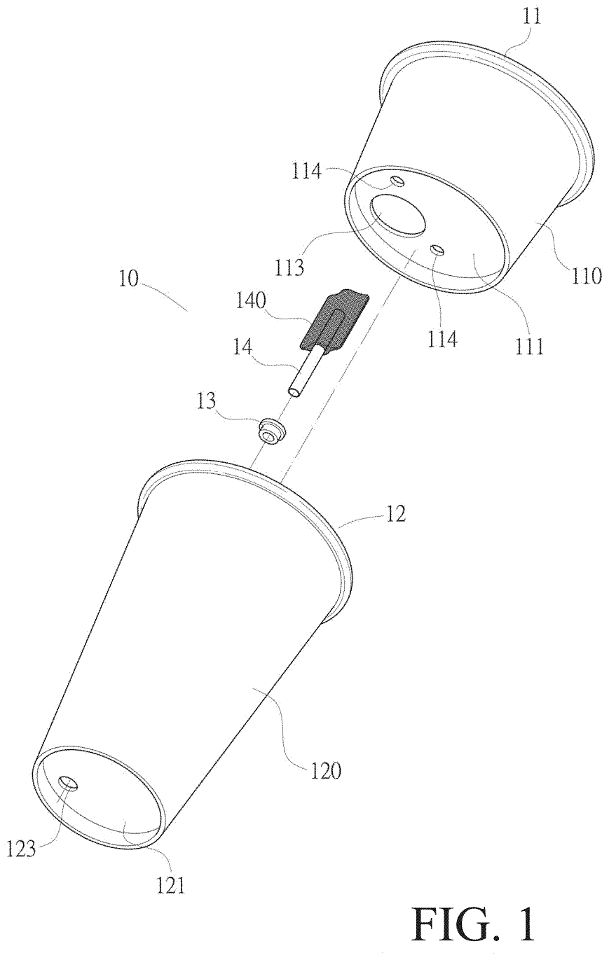

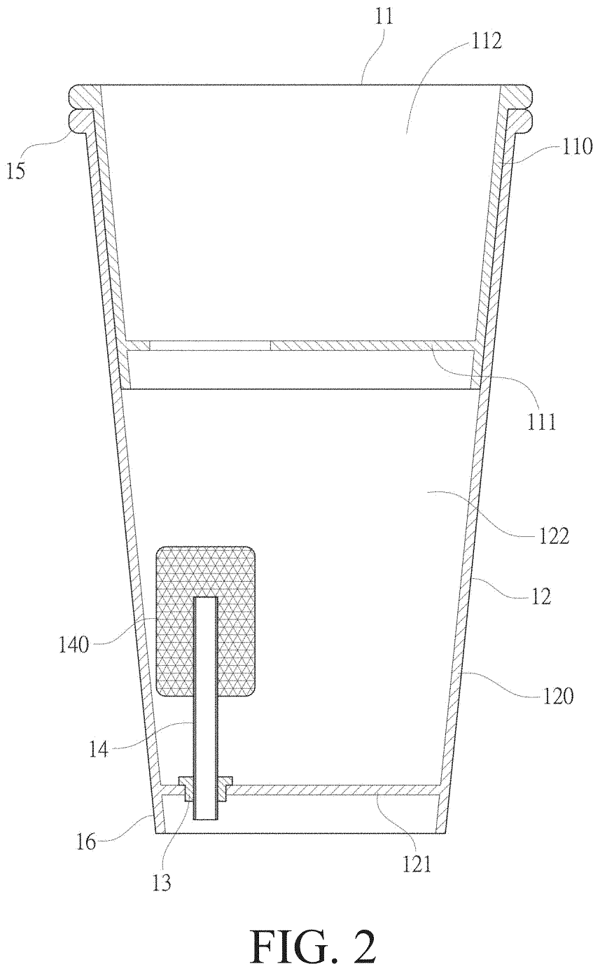

With reference to FIGS. 1-4, a portable container 10 for planting a hydroponic vegetable according to a preferred embodiment of the present invention comprises: a first cup 11, a second cup 12, a plug 13, and a drain pipe 14.

The first cup 11 includes a first peripheral fence 110, a first bottom 111, a first accommodation chamber 112 defined between the first peripheral fence 110 and the first bottom 111, and at least one first planting orifice 113 and at least through orifice 114 which are formed adjacent to the first peripheral fence 110, wherein the at least one first planting orifice 113 is configured to accommodate a porous carrier 20 so that stems 210 and leaves 211 of the hydroponic vegetable 21 grow in the first accommodation chamber 112, and the at least through orifice 114 is configured to avoid a blocking of the at least one first planting orifice 113 after the hydroponic vegetable 21 grows.

The second cup 12 is fixed below the first cup 11, and the second cup 12 includes a second peripheral fence 102 and a second bottom 121, wherein a perimeter of the first peripheral fence 110 is less than the second peripheral fence 120 so that a second accommodation chamber 122 is defined among the second peripheral fence 120, the first bottom 111, and the second bottom 121, and a root 212 of the hydroponic vegetable 21 grows, wherein the second peripheral fence 120 has a discharge orifice 123.

The plug 13 is connected with the discharge orifice 123.

An outer diameter of the drain pipe 14 is more than an inner diameter of the plug 13, and the drain pipe 14 is made of flexible plastic so that a lower end of the drain pipe 14 erects after being pressed into the plug 13, wherein the drain pipe 14 includes a nylon mesh 140 adhered on an upper end thereof, and a peripheral side of the nylon mesh 140 is heat sealed so as to avoid the root 212 of the hydroponic vegetable 21 blocking the drain pipe 14.

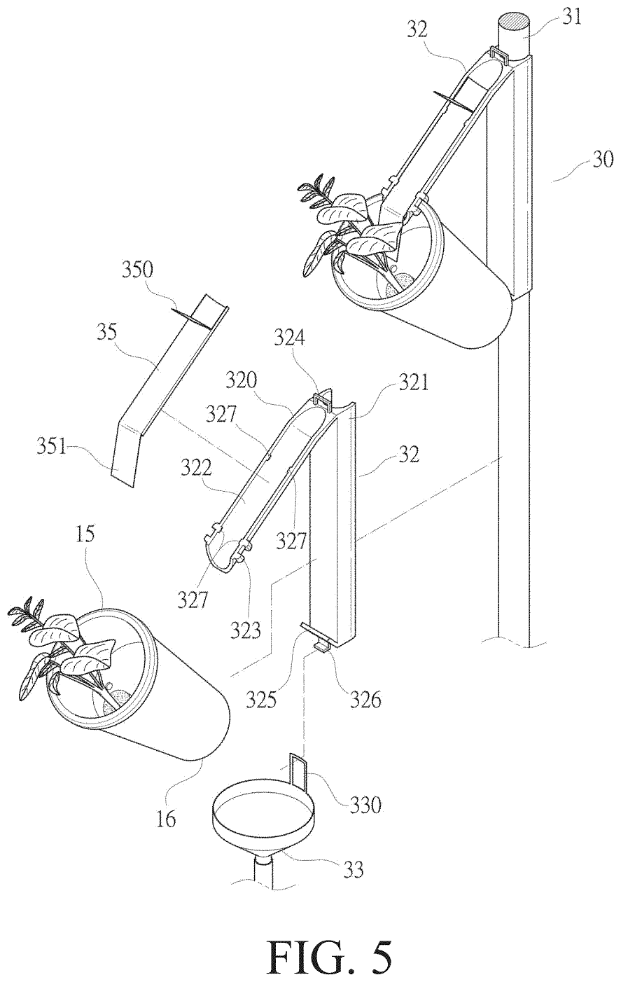

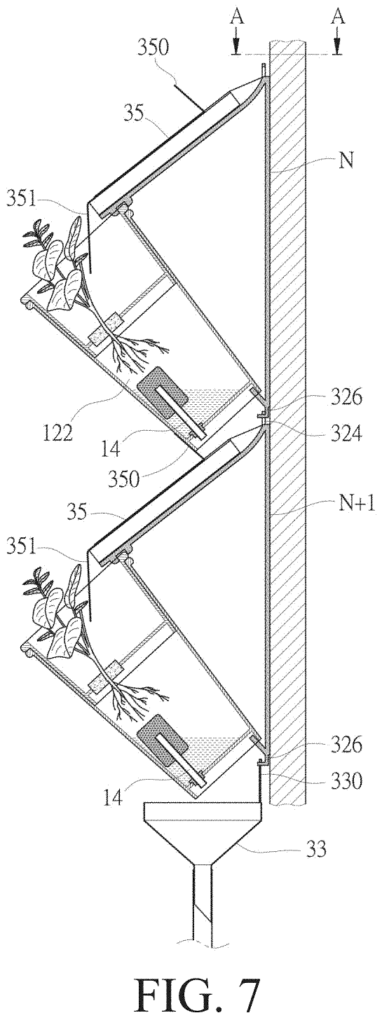

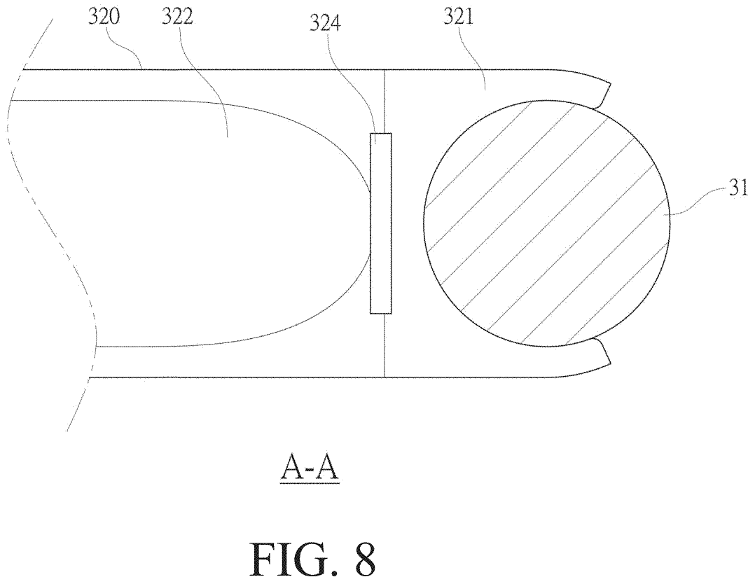

Referring to FIGS. 5-9, a portable device 30 for planting the hydroponic vegetable according to the preferred embodiment of the present invention comprises: a cylindrical support 31 and multiple holders 32 fixed on the cylindrical support 31, wherein each of the multiple holders 32 includes a guide portion 320, an engagement portion 321, a groove 322 defined on the guide portion 329, two recesses 323 formed on two sides of a lower end of each holder 32 respectively, a U ring 324 arranged between the guide portion 320 and the engagement portion 321, a locking rib 325 extending upward from a lower end of each holder 32, and an L hook 326 extending downward from the lower end of each holder 32, wherein a cross section of the engagement portion 321 is in a C shape, and the engagement portion 321 is movably engaged on the cylindrical support 31. The portable device 30 further comprises a funnel 33 which includes a U loop 330 extending from an upper end of the funnel 33 and is fixed on a distal end of the cylindrical support 31. The portable device 30 further comprises a hanging element 34 configured to hang the portable device 30 on a wall, wherein a L fixer 326 of a N^{th} holder 32 of the multiple holders 32 is hooked with a U ring 324 of a (N+1)^{th} holder 32, and a L fixer 326 of a last holder 32 is hooked with the U loop 330 of the funnel 33, thus fixing the multiple holders 32.

In operation, multiple portable containers 10 are accommodated in the multiple holders 32 respectively, wherein an positioning rib 15 of each of the multiple portable containers 10 is engaged with the two recesses 323 of each holder 32, a contacting face of each portable container 10 is engaged with the locking rib 325 so that each portable containers 10 is obliquely accommodated in each holder 32, wherein the at least one first planting orifice 113 is formed on a lowest position of the first bottom 111, and the discharge orifice 123 is formed on a lowest position of the second bottom 121 lower than lower than the L hook 326, a discharge orifice 123 of a N^{th} portable container 10 is defined higher than a groove 322 of the (N+1)^{th} holder 32, and a discharge orifice 123 of a last portable container 10 is higher than the funnel 33.

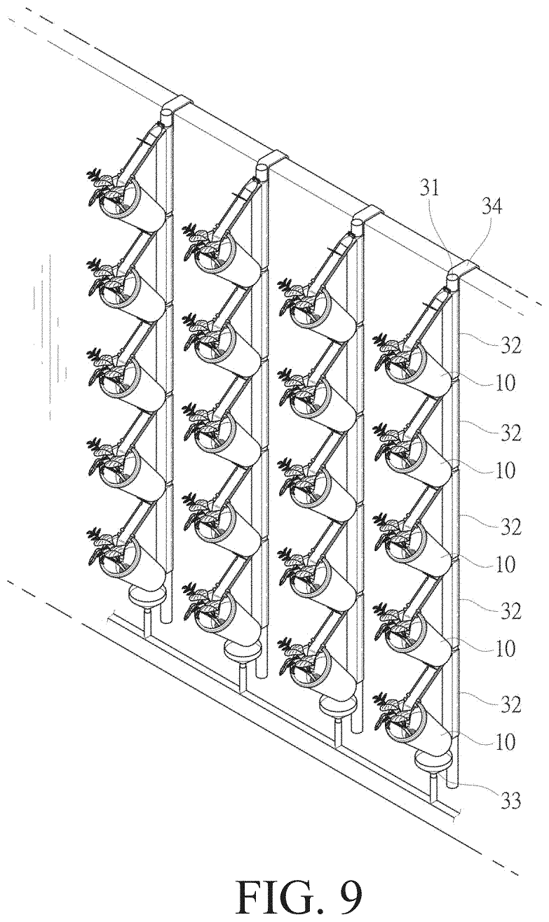

In operation, a fluid is dropped into the second accommodation chamber 122 along the at least one first planting orifice 113 or the at least through orifice 114 from the N^{th} portable container 10, then the fluid flows into a water tank via the drain pipe 14, the discharge orifice 123, the groove 322 of the (N+1)^{th} holder 32, and the (N+1)^{th} portable container 10, the funnel 33, and the last portable container 10, thus recycling the fluid. Referring to FIG. 9, multiple portable containers 10 are vertically fixed on each of the multiple cylindrical supports 31 so as to plant hydroponic vegetables.

When harvesting the hydroponic vegetables 21, the multiple portable containers 10 are removed from the portable device 30 so as to be portable with the hydroponic vegetables 21, thus saving harvest and package costs. Thus, new portable containers 10 are replaced onto the portable device 30, wherein multiple first cups 11 and multiple second cups 12 of the new portable containers 10 are made of paper.

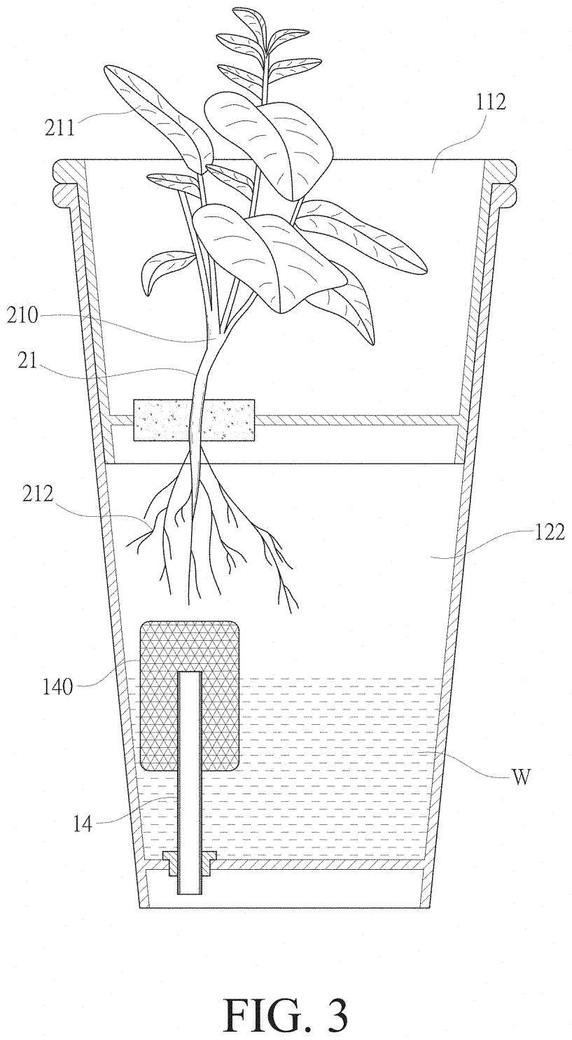

As shown in FIG. 3, in the harvest, the fluid W is accommodated in the portable container 10 so as to facilitate growing of the hydroponic vegetable 21, and the fluid W does not leak from the drain pipe 14 by ways of the nylon mesh 140.

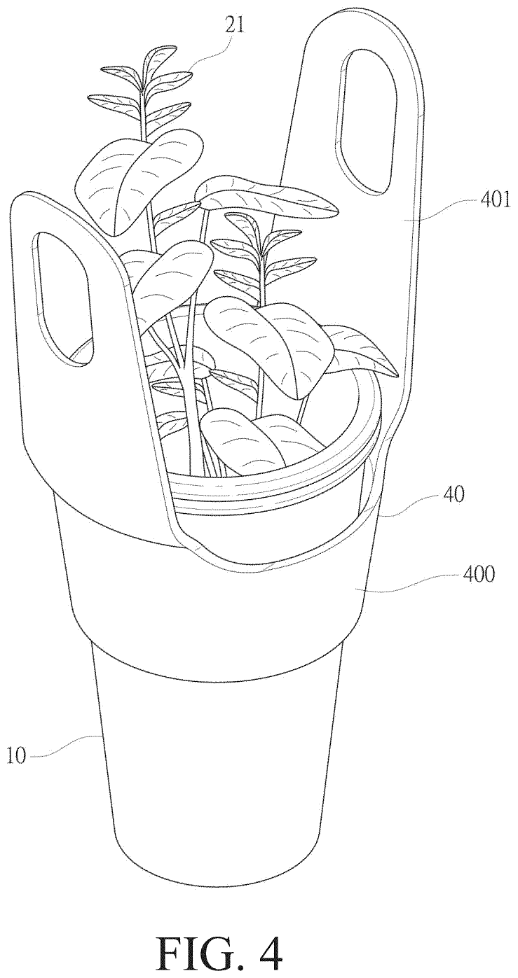

As shown in FIG. 4, a fitting sleeve 40 is configured to fit with the portable container 10 and includes a fitting portion 400 and at least one extension 401, thus carrying the portable container 10 with the hydroponic vegetable 21.

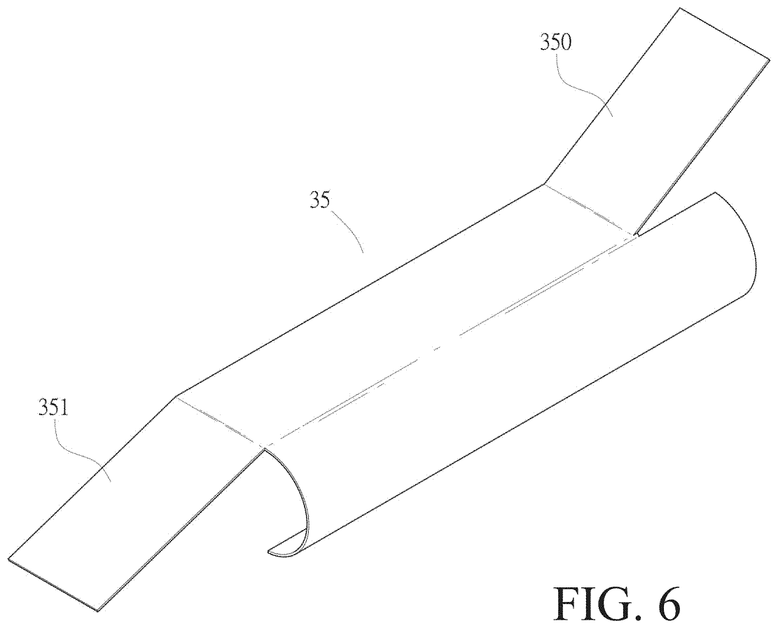

As illustrated in FIG. 6, each holder 32 further has a flowing tube 35 extending along the groove 322, wherein the flowing tube 35 is made of paper, and a waterproof film is covered on the flowing tube 35, the flowing tube 35 has a contact portion 350 and a conduct portion 351 which are foldable so that the fluid flows through the flowing tube 35. The groove 322 has four locking elements 327 mounted thereon so as to lock the flowing tube 35 with the groove 322. The contact portion 350 is engaged with the second peripheral fence 120 of the portable container 10 so as to position the flowing tube 35, and the conduct portion 351 is configured to avoid a leakage of the fluid from the flowing tube 35, for example, the fluid flows out of the portable container 10 along the leaves 211 of the hydroponic vegetable 21. Preferably, the lowing tube 35 is replaceable after harvesting the hydroponic vegetable 21.

Accordingly, the portable container of the present invention has advantages as follows:

1. The multiple portable containers are vertically fixed on each of the multiple cylindrical supports so as to plant hydroponic vegetables and to recycle the fluid.

2. After harvesting the hydroponic vegetables, the multiple portable containers are removed from the multiple holders, and the multiple fitting sleeves 40 are fitted with the portable containers 10 respectively, thus carrying the portable containers 10 easily.

3. Each portable container 10 is obliquely accommodated in each holder 32, and the fluid is maintained in a predetermined water level of each portable container by using the drain pipe 14 so as to plant the hydroponic vegetable 21 in each portable container 10 freshly.

4. Each portable container 10, each holder 32, and the flowing tube 35 are replaceable after harvesting the hydroponic vegetable 21, thus obtaining hygiene.

5. The hanging element 34 is configured to hang the portable device on the wall so as to plant the hydroponic vegetable 21 easily.

6. The engagement portion 321 of each holder 32 is movably engaged on the cylindrical support 31, hence after removing one holder 32, anther holder 32 is dropped so as to harvest its hydroponic vegetable easily.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A portable container for planting a hydroponic vegetable being obliquely accommodated in and removed from a portable device, the portable container comprising:
a first cup including a first peripheral fence, a first bottom, a first accommodation chamber defined between the first peripheral fence and the first bottom;
the first cup including at least one first planting orifice and at least through orifice which are formed adjacent to the first peripheral fence, wherein the at least one first planting orifice is configured to accommodate a porous carrier so that the hydroponic vegetable grows in the first accommodation chamber;
a second cup fixed below the first cup, and the second cup including a second peripheral fence and a second bottom, wherein a perimeter of the first peripheral fence is less than the second peripheral fence so that a second accommodation chamber is defined among the second peripheral fence, the first bottom, and the second bottom, and a root of the hydroponic vegetable grows;
the second peripheral fence having a discharge orifice;
a plug connected with the discharge orifice;
an outer diameter of the drain pipe being more than an inner diameter of the plug, a lower end of the drain pipe being pressed into the plug, the drain pipe including a nylon mesh adhered on an upper end thereof;
each portable containers is obliquely accommodated in the portable device, wherein the at least one first planting orifice is formed on a lowest position of the first bottom, and the discharge orifice is formed on a lowest position of the second bottom;
wherein a fluid is dropped into the second accommodation chamber along the at least one first planting orifice.

2. The portable container as claimed in claim 1 further comprising a fitting sleeve configured to fit with the portable container and including a fitting portion and at least one extension.

3. The portable container as claimed in claim 1, wherein the first cup and the second cup are made of paper.

4. A portable device for planting a hydroponic vegetable comprising:
a cylindrical support;
multiple of holders fixed on the cylindrical support;
wherein each of the multiple holders includes a guide portion and an engagement portion;
wherein each holder further includes a groove defined on the guide portion, and each holder includes two recesses formed on two sides of a lower end of each holder respectively;
wherein each holder includes a U ring arranged between the guide portion and the engagement portion, a locking rib extending upward from a lower end of each holder, and an L hook extending downward from the lower end of each holder, wherein a cross section of the engagement portion is in a C shape, and the engagement portion is movably engaged on the cylindrical support;
wherein the portable device further comprises a funnel which includes a U loop extending from an upper end of the funnel and is fixed on a distal end of the cylindrical support;
wherein a L fixer of a N^{th} holder of the multiple holders is hooked with a U ring of a (N+1)^{th} holder;
wherein a L fixer of a last holder is hooked with the U loop of the funnel;
wherein multiple portable containers of claim 1 are accommodated in the multiple holders respectively, wherein an positioning rib of each of the multiple portable containers is engaged with the two recesses of each holder, a contacting face of each portable container is engaged with the locking rib so that each portable containers is obliquely accommodated in each holder;
wherein a discharge orifice of a N^{th} portable container is defined higher than a groove of the (N+1)^{th} holder; and
wherein a discharge orifice of a last portable container is higher than the funnel.

5. (Orirginal) The portable device as claimed in claim 4, wherein each holder further has a flowing tube extending along the groove, the flowing tube is made of paper, the flowing tube has a contact portion and a conduct portion;
wherein the groove has four locking elements mounted thereon.

6. The portable device as claimed in claim 4 further comprising a hanging element configured to hang the portable device on a wall.
